(19) United States
(12) Patent Application Publication
(10) Pub. No.: US 2014/0377062 A1
(43) Pub. Date: Dec. 25, 2014

(54) DEVICE AND METHOD FOR ROTATING A ROTOR OF A WIND TURBINE

(71) Applicant: SIEMENS AKTIENGESELLSCHAFT, MUNCHEN (DE)

(72) Inventors: VERNER BECH JAKOBSEN, VIDEBAEK (DK); THORKIL MUNK-HANSEN, GIVE (DK); HENNING POULSEN, SKJERN (DK)

(73) Assignee: SIEMENS AKTIENGESELLSCHAFT, MUNCHEN (DE)

(21) Appl. No.: 14/284,424

(22) Filed: May 22, 2014

(30) Foreign Application Priority Data
Jun. 24, 2013 (DE) 102013211934.8

(51) Int. Cl. F03D 1/06

(52) U.S. Cl. CPC F03D 1/06
USPC 416/1; 416/204 R

(57) ABSTRACT

The invention relates to a device for rotating a rotor of a wind turbine. Here, the wind turbine has the rotor, a tower, a nacelle with a machine frame, and a hub on which at least one rotor blade can be mounted. The rotor is arranged so as to be rotatable relative to the nacelle about an axis of rotation. The wind turbine furthermore has a locking device for blocking a rotational movement of the rotor about the axis of rotation. The device has at least one first displacement unit which is fastened to the machine frame. The first displacement unit also has a fastening device by means of which the first displacement unit can be detachably fastened to the rotor. Finally, the fastening device is actuable, in particular electrically and/or hydraulically actuable. The invention furthermore relates to a system for rotating one rotor of the wind turbine. The invention finally relates to a method for rotating the rotor of the wind turbine by means of the device or by means of the system.

### CROSS-REFERENCE TO RELATED APPLICATIONS

This application claims priority to DE 102013211934.8 filed on Jun. 24, 2013, the disclosure of which is herewith incorporated by reference in its entirety.

### FIELD OF TECHNOLOGY

The following relates to a device for rotating a rotor of a wind turbine and to a system for rotating the rotor. The embodiment also relates to a method for rotating the rotor by means of the device, and to a method for rotating the rotor by means of the system.

### BACKGROUND

A controlled rotation of a rotor of a wind turbine is desirable and/or necessary in a variety of situations. This is the case for example when a rotor blade of a wind turbine is installed on a hub of the wind turbine, for example during the erection of the wind turbine. A controlled rotation of a rotor of a wind turbine is also desirable or necessary for example during maintenance of the wind turbine.

Attaching a rotation device by means of which the rotor can be rotated is challenging because, firstly, there is typically little space available for the rotation device in a nacelle of the wind turbine, where secondly, a high torque is required for rotating the rotor. A high torque is required in particular in the case of a gearbox-free wind turbine.

The patent EP 1 659 286 B1 discloses a turning device which comprises a linear actuator, one end of which is fastened with angular mobility to a machine frame of the wind turbine and the other end of which is fastened with angular mobility to a flange of the drive train. A disadvantage of the disclosed device is the large linear actuators, which take up a large amount of space. Furthermore, it is not clear from the cited document how the linear actuators are specifically fastened, in an efficient manner, to the drive train.

### SUMMARY

An aspect relates to a method for rotating a rotor of a wind turbine, which method can be used for example for installation of the rotor blade or for maintenance work on the wind turbine, thus making it more efficient. A second consists in providing a device for carrying out a method of said type.

This aspect is achieved as claimed in the coordinate claims. The subclaims specify advantageous refinements.

To achieve the aspect, a device for rotating a rotor of a wind turbine is specified. Here, the wind turbine has the rotor, a tower, a nacelle with a machine frame, and a hub on which at least one rotor blade can be mounted. The rotor is arranged so as to be rotatable relative to the nacelle about an axis of rotation. The wind turbine furthermore has a locking device for blocking a rotational movement of the rotor about the axis of rotation. The device has at least one first displacement unit which is fastened to the machine frame. The first displacement unit also has a fastening device by means of which the first displacement unit can be detachably fastened to the rotor. Finally, the fastening device is actuatable, in particular electrically and/or hydraulically actuatable.

A wind turbine can convert wind energy into electrical energy. A wind turbine is also referred to as a wind energy installation, as a wind power plant or as a wind power converter.

In particular, the wind turbine has at least one rotor blade. The wind turbine advantageously has three rotor blades. The rotor blade has a rotor blade longitudinal axis extending from a rotor blade tip region to a rotor blade root region.

The device for rotating the rotor will hereinafter also be referred to as a rotation device.

The first displacement unit of the rotation device may be fastened to the machine frame by means of a screw or a bolt, for example an M24 bolt.

The first displacement unit is also fastened to the rotor. Here, the fastening device is configured such that the first displacement unit can be fastened to the rotor in a detachable and re-connectable, that is to say re-fastenable.

It is advantageous for the first displacement unit to be fastened to a rotor part which belongs to a generator of the wind turbine and which is also referred to as generator-rotor.

The locking device is generally suitable for ensuring that the rotor is kept at a standstill, that is to say is blocked. The locking device is used for example in the event of high winds, for example a storm, in the event of icing of the rotor blades and/or during maintenance of the wind turbine. The locking device is connected to the machine frame in a fixed, that is to say mechanically rigid and stable, manner. Furthermore, the locking device may be connected to the rotor by means of a bolt or a screw. The locking device may also have multiple means or elements for connecting it to the rotor.

The rotation device is advantageously situated within the nacelle, because, in this way, the rotation device is mounted or positioned on the tower together with the nacelle during the assembly and erection of the wind turbine, without additional outlay.

After the rotation device has been used for the mounting of the rotor blades, the rotation device may be removed again. This is advantageously performed, for the rotation device as a whole, through an opening in the nacelle, for example by means of a crane. If the rotation device as a whole is too heavy for the crane, the rotation device may also be broken down into multiple individual parts owing to its modular construction.

In a first embodiment, the fastening device is actuatable by means of a programmable control device.

The control device may be integrated into an overall controller device of the wind turbine. The control device may alternatively also be configured separately from the overall controller device. The control device is advantageously programmable in order to make it possible to realize different movement patterns, in other words different modes. The different movement patterns relate to different rotational movements of the rotor.

Fastening and release of the fastening device in a manner automated by means of the control device has numerous significant advantages: firstly, in this way, it is possible to realize controlled and reproducible movements, that is to say rotational movements of the rotor. Secondly, by means of an automated control device, there is no longer a need for manual fastening and release of the fastening device. This means that, for example, a technician for fastening and releasing the fastening device manually or using auxiliary aids can be dispensed with. Finally, an automated solution is advantageous in that there is no need to provide space for a person for manually fastening and releasing the fastening device. This is of great advantage in particular in a wind turbine, in the nacelle of which available space is valuable and scarce.

In a further embodiment, the device comprises a connecting element which connects the fastening device to the first displacement unit.

It is advantageous for the first displacement unit not to be fastened directly to the rotor, and instead for the first displacement unit to be fastened to the rotor via the connecting element. The connecting element may be in the form of a plate, that is to say may be of flat form. The connecting element may thus have a connecting plate with corresponding cutouts for the fastening of the first displacement unit and of the fastening device.

In one advantageous embodiment, the machine frame comprises a brake bracket to which the first displacement unit is fastened.

It is advantageous for the brake bracket to be fixed to a main shaft, which is also referred to as main axle. The main shaft may be regarded as a static part of a generator of the wind turbine. In the terminology of this patent application, however, the main shaft is a part of the machine frame. Parts of a stator may be fastened to the main shaft.

The brake bracket may be in the form of a disk with an outer edge and an inner edge. The outer and inner edges may be substantially circular. Furthermore, on the outer edge, there may be fitted brake pads which are placed in direct contact with the rotor during the braking of the rotor.

In a further advantageous embodiment, the rotor has a brake disk to which the first displacement unit can be detachably fastened.

When the brake pads are actuated, for example hydraulically actuated, the brake pads can be placed in contact with the brake disk.

The brake disk is advantageously fastened to the rest of the rotor by means of a flange. The brake disk may have cutouts, for example circular holes, by means of which the first displacement unit is connected directly to the brake disk.

In a further advantageous embodiment, the first displacement unit comprises a hydraulic displacement unit, in particular a hydraulic cylinder.

A hydraulic cylinder is a working cylinder operated by means of a liquid. A hydraulic cylinder is also referred to as a hydraulic linear motor. In a hydraulic cylinder, energy from a hydraulic liquid, which may be delivered from a hydraulic pressure accumulator or a hydraulic pump, is converted into a rectilinearly acting, easily controllable force.

In one advantageous embodiment, the first displacement unit comprises a further hydraulic displacement unit, in particular a further hydraulic cylinder.

It is advantageous for the further hydraulic displacement unit to be of the same design as the hydraulic displacement unit. An advantage of this, if the rotation device has at least two hydraulic displacement units, specifically at least the hydraulic displacement unit and the further hydraulic displacement unit, is that the individual hydraulic displacement units themselves do not need to be designed to be as large as a single hydraulic displacement unit, while imparting a similar level of torque for effecting the rotation of the rotor.

The rotation device advantageously has a connecting element in twofold configuration. Said two connecting elements may advantageously be attached to opposite sides of the rotor. This can reduce shear forces that act for example perpendicular to a stroke movement of the displacement unit.

In a further advantageous embodiment, the hydraulic displacement unit and the further hydraulic displacement unit are arranged substantially parallel to one another.

The expression “substantially” encompasses a deviation of up to 10°, or up to 5°, between a longitudinal axis of the hydraulic displacement unit and a further longitudinal axis of the further hydraulic displacement unit.

It is advantageous for both hydraulic displacement units to be connected to the machine frame and/or to the rotor through the same cutouts. This reduces production outlay, in particular for the connecting element, and can assist in achieving a parallel arrangement of the hydraulic displacement units.

In one advantageous embodiment, the wind turbine is a direct-drive wind turbine.

A direct-drive wind turbine is to be understood to mean a gearbox-free wind turbine, that is to say a wind turbine without a gearbox. The rotation device is advantageous in particular for a gearbox-free wind turbine, because, in the case of a gearbox-free wind turbine, is not possible, for example, for use to be made of a motor-driven rotation device which can utilize for example a transmission ratio and/or a change speed gear of the generator in order to rotate the rotor.

In a further advantageous embodiment, the device has at least one second displacement unit for assisting the rotation of the rotor, and the second displacement unit is fastened to the machine frame.

The addition of the second displacement unit makes it possible, in principle, to achieve an increase in the torque that the device can impart in order to rotate the rotor. This is advantageous for example if the available space for the rotation device is limited or constricted. Owing to the addition of the second displacement unit, the first displacement unit does not need to be of relatively large dimensions; it is merely necessary for space to be created for the displacement unit.

It is furthermore advantageous if a movement of the two displacement units, that is to say of the first displacement unit and of the second displacement unit, can be controlled and performed in a precise manner. This is possible, and advantageous, for example by means of programming of the two displacement units, in particular of the two hydraulic cylinders. An overall force of the rotation device may for example be made up of a compressive force, provided primarily by the first displacement unit, and of a tensile force, provided primarily by the second displacement unit.

In one advantageous embodiment, the first displacement unit and the second displacement unit are connected to one another by way of a connecting unit. Here, the connecting unit is connected rotatably to the first displacement unit and rotatably to the second displacement unit.

In a further advantageous embodiment, the first displacement unit has a first support device and/or the second displacement unit has a second support device.

A function of the first support device and/or of the second support device is to make it possible to control deflections of the first displacement unit and/or of the second displacement unit both in the axial direction and also in the radial direction. Here, the terms “axial” and “radial” relate to the axis of rotation. In other words, a force in the axial direction acts parallel to the axis of rotation, whereas a force in the radial direction acts perpendicular to the axis of rotation.

Advantageous embodiments of the two support devices are specified below:

In a first advantageous embodiment, the first support device has a first radial support unit and/or a first axial support unit. In a second advantageous embodiment, the second support device has a second radial support unit and/or a second axial support unit.

The radial support units support the displacement units substantially in a radial direction, and the axial support units displace the displacement units in a direction substantially parallel to the axis of rotation. Here, the term “substantially” encompasses deviations of up to 20°, in particular of up to 10°, in relation to a state of parallelism between the axial support units and the axis of rotation and in relation to a state of orthogonality between the radial support units and the axis of rotation. For example, if the second displacement unit is designed to be of considerably lower power than the first displacement unit, wherein “considerably” encompasses a factor or a ratio of at least 3 and “lower power” relates to the torque, it is advantageous for the second axial support unit to be dispensed with for reasons of cost.

In a further embodiment, the machine frame has a tower bearing frame, and the second displacement unit is fastened to the tower bearing frame.

The tower bearing frame is a part of a tower bearing. A tower bearing is also referred to as “yaw bearing” and permits a rotation of the nacelle relative to the tower about a vertical axis also referred to as yaw axis. The tower bearing frame is advantageously of ring-shaped form, and in this case is also referred to as yaw ring.

In a further embodiment, the rotation device can have a safety device for preventing an inadvertent release of a connection between the first displacement unit and the rotor. It is advantageously the case that the safety device has a bolt, in particular a spring-actuated bolt, and that the rotor has a cutout matched to the bolt.

For example, the rotor has a part in the shape of a hollow cylinder. That part of the rotor, which is for example a part of the brake disk, hereinafter also referred to as rotor part, has cutouts which are matched to the bolt and which will hereinafter also be referred to as safety device cutouts. Furthermore, the rotor part also has fastening device cutouts. For example, the safety device cutouts and the fastening device cutouts are each arranged in a circular manner around the circumference. In this example, the bolt is advantageously configured so as to engage into the safety device cutouts under the action of a spring. Owing to the arrangement of the fastening device and of the bolt, the engagement of the bolt into the safety device cutout takes place precisely when the fastening device engages into the fastening device cutout. Since the spring-actuated bolt can be retracted only for example electrically, said bolt constitutes a safety mechanism for blocking the rotor or for preventing an inadvertent release of the blocking action.

Embodiments also relate to a system for rotating a rotor of a wind turbine, wherein the system has at least two, at least three devices for rotating the rotor of the wind turbine.

An advantage of the system comprising multiple rotation devices is the overall torque obtained by the addition of individual torques of the rotation devices. A further advantage of the system is a time saving that can be gained owing to the use of multiple rotation devices. For example, it is possible for the second rotation device to perform a rotation of the rotor while, at the same time, the first displacement unit, for example the first hydraulic cylinder, returns into a starting position immediately after having performed a rotational movement.

In one advantageous embodiment, the rotation devices are situated around the circumference at substantially equal radial distances from the axis of rotation.

This is advantageous in particular in the case of a circular fastening surface, to which the rotation devices are fastened, of the rotor.

If there is an even number of rotation devices, it is advantageous for in each case two rotation devices to be arranged opposite one another.

A system comprises for example two rotation devices which each have a hydraulic displacement unit and a further hydraulic displacement unit which are arranged parallel to one another.

Embodiments also relate to a method for rotating a rotor of a wind turbine by means of a device for rotating the rotor of the wind turbine.

The method advantageously has the following steps:
a) blocking the rotor by means of the locking device;
b) fastening the first displacement unit to the rotor by means of the fastening device;
c) releasing the locking device;
d) rotating the rotor from a first stroke position into a second stroke position by means of a first stroke change movement of the first displacement unit;
e) blocking the rotor by means of the locking device;
f) releasing the first displacement unit from the rotor; and
g) performing a second stroke change movement of the first displacement unit from the second stroke position into the first stroke position.

It is advantageously possible for the fastening in step b) to be performed using multiple fastening means. Said multiple fastening means may fasten the first displacement unit to the rotor simultaneously or in succession.

The first stroke change movement in step b) and the second stroke change movement in step g) may comprise both a deployment or extension of the first displacement unit, for example of the hydraulic cylinder, or a compression or retraction of the first displacement unit, for example of the hydraulic cylinder.

A function of step g) is a movement of the first displacement unit into a position that forms the basis of step a). This is for the purpose of making it possible to commence with step a) again after step g).

In practice, it is advantageous for a rotational movement composed of multiple individual rotational movements as described in the method according to steps a) to g) to be performed.

In one advantageous embodiment, the rotor is rotated through at least 3°, or through at least 5°, by means of the first stroke change movement and/or by means of the second stroke change movement.

This is advantageously the case if only one displacement unit, that is to say only the first displacement unit, is provided.

In a further advantageous embodiment, the rotor is rotated through at least 10°, or through at least 20°, by means of the first stroke change movement and/or by means of the second stroke change movement.

This is the case if at least two displacement units, that is to say the first displacement unit and at least the second displacement unit, are provided.

In a further advantageous embodiment, in a further step, the rotor blade is mounted on the hub. This is performed while a rotor blade longitudinal axis extending from the rotor blade tip region to the rotor blade root region is arranged substantially horizontally.

Here, the term “substantially” refers to a deviation of up to 20°, or up to 10°, between the rotor blade longitudinal axis and an axis which is horizontal relative to the earth's surface. Mounting in a vertical direction or mounting at some other angle is basically also possible. Owing to a limitation of the crane height, fluttering of the rotor blade owing to wind and/or a facility for preloading the rotor blade, however, horizontal mounting of the rotor blade is advantageous. In order to mount three rotor blades, for example, on the hub, at least two rotational movements of the rotor through in each case approximately 120° are required. Said rotational movements are advantageously performed by means of a method such as is disclosed in this embodiment and by means of a rotation device as disclosed within the context of this embodiment.

### BRIEF DESCRIPTION

Some of the embodiments will be described in detail, with reference to the following figures, wherein like designations denote like members, wherein:

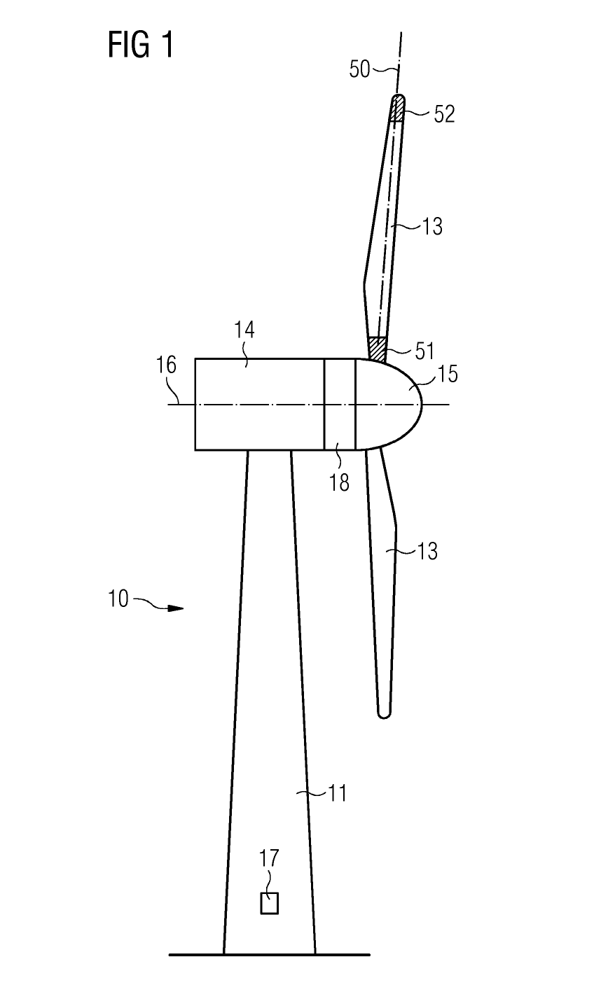

FIG. 1 shows a wind turbine;

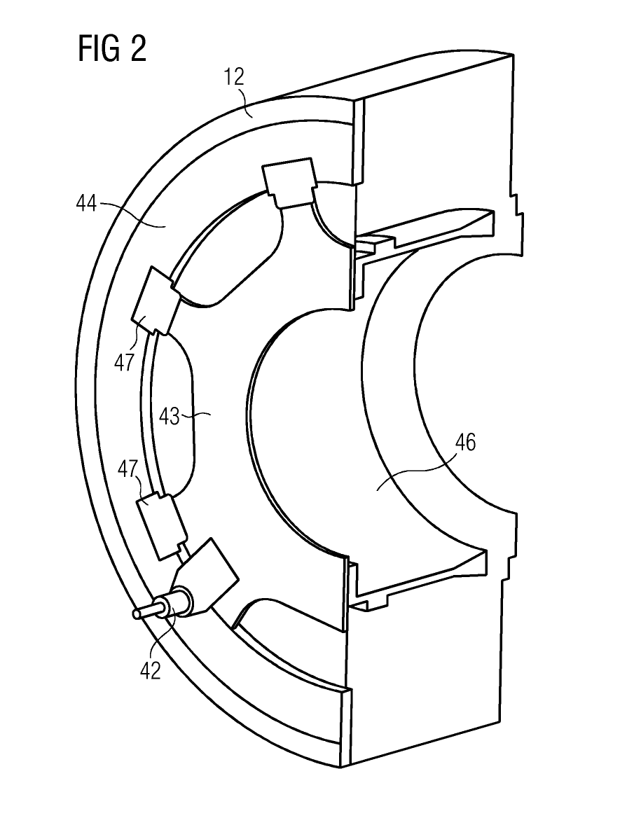

FIG. 2 shows a detail of a rotor and of a main shaft;

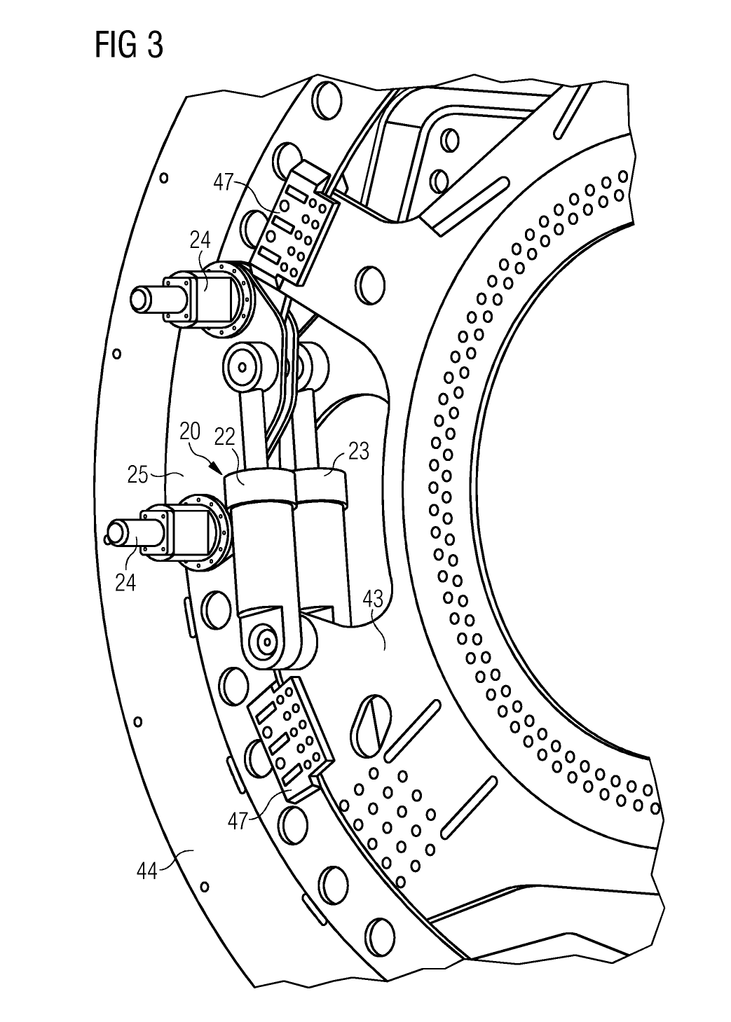

FIG. 3 shows a first displacement unit in a first stroke position;

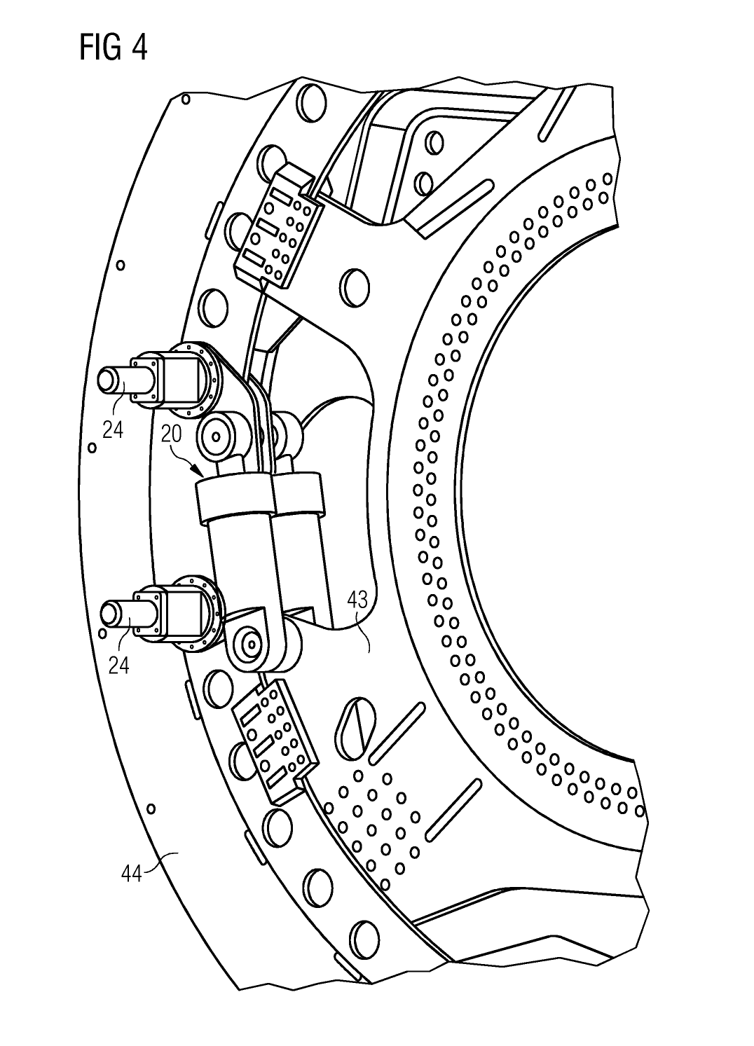

FIG. 4 shows a first displacement unit in a second stroke position;

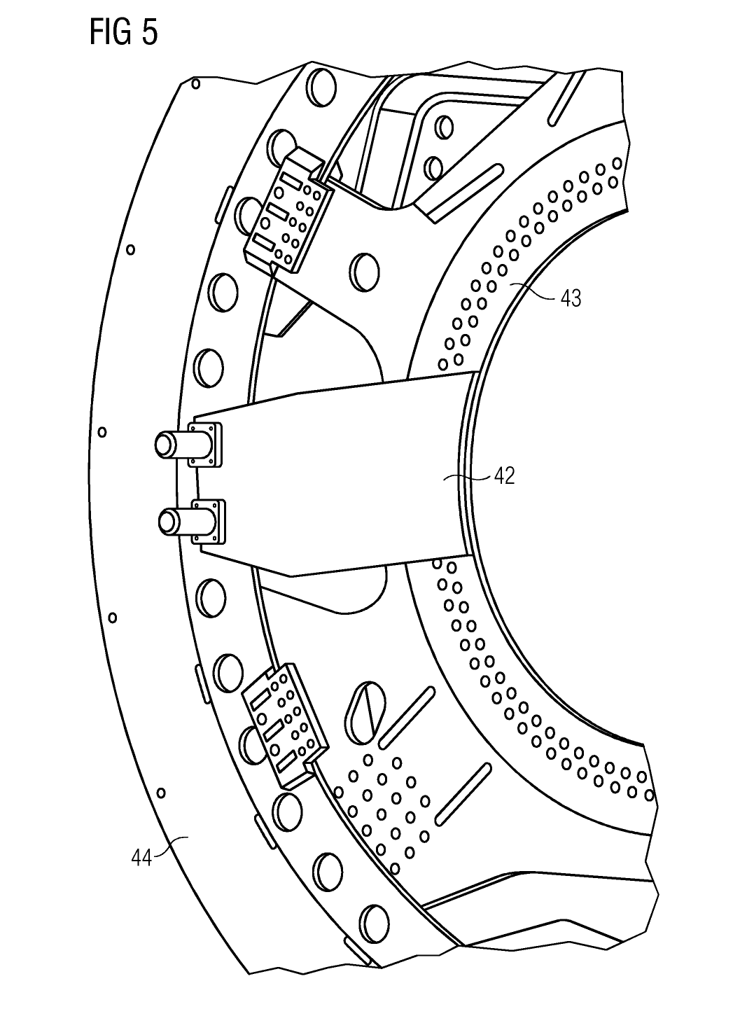

FIG. 5 shows a locking device;

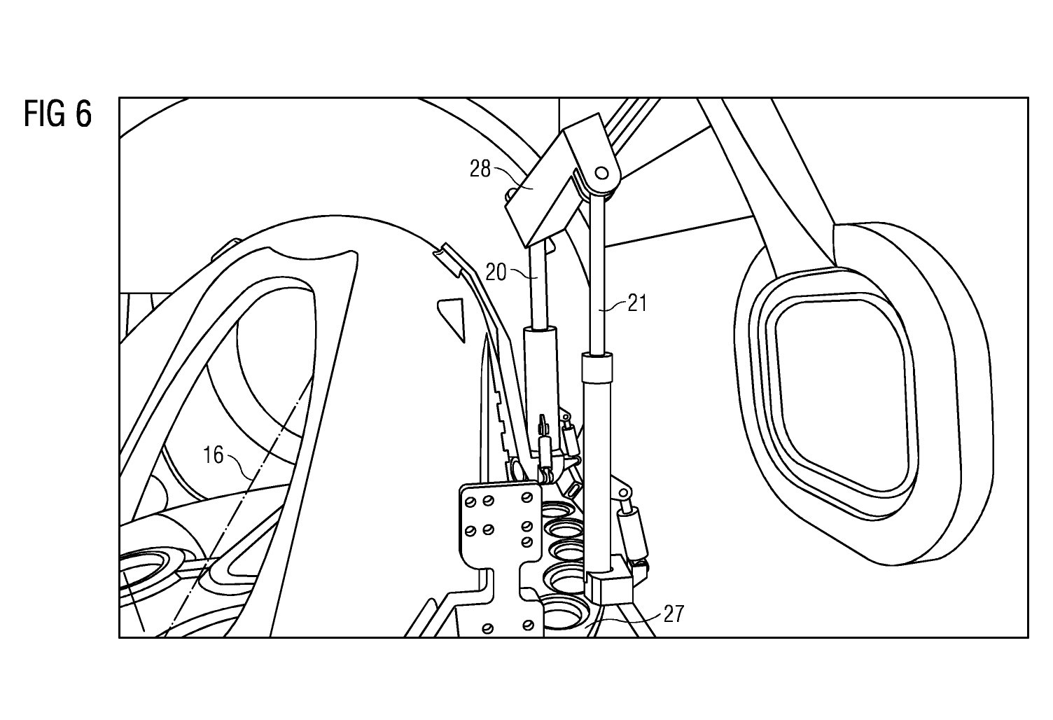

FIG. 6 shows a first displacement unit and a second displacement unit which is connected to a connecting unit;

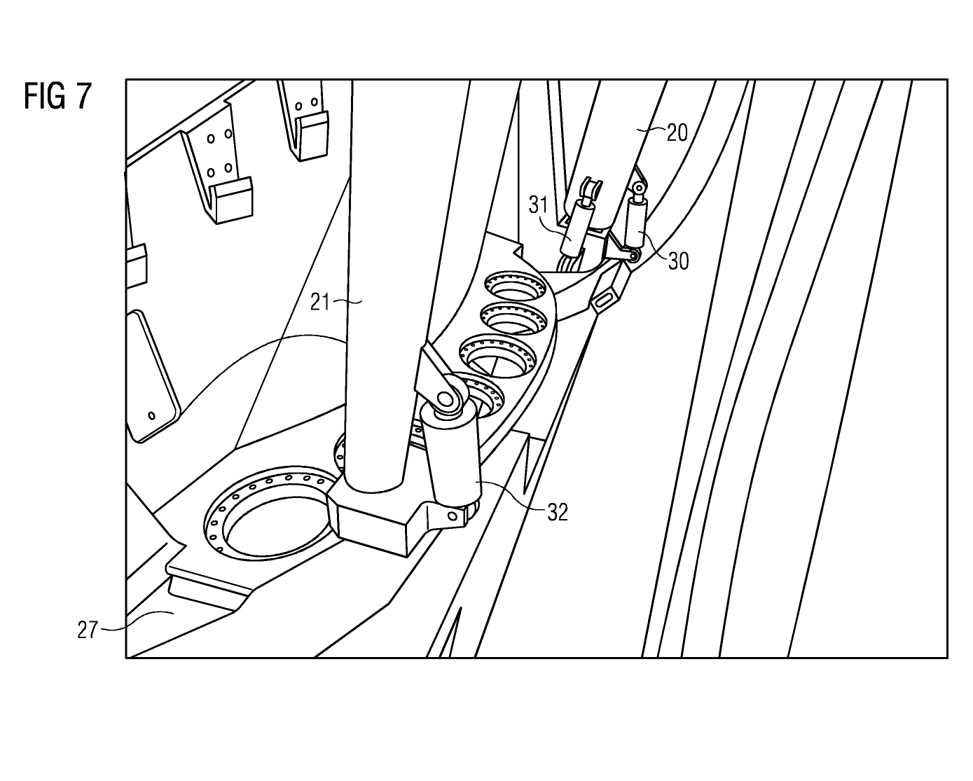

FIG. 7 shows a first displacement unit and a second displacement unit with support units; and

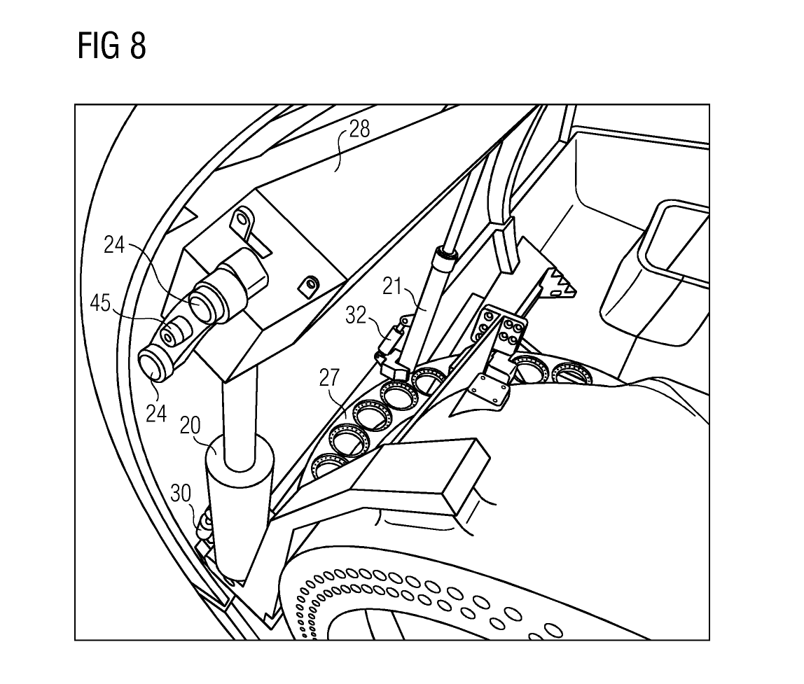

FIG. 8 shows a safety device.

### DETAILED DESCRIPTION

FIG. 1 shows a wind turbine 10 with a tower 11 and a nacelle 14. The nacelle 14 is rotatably connected to the tower 11 by way of a tower bearing (not shown). The nacelle 14 is furthermore connected to a hub 15 on which two rotor blades 13 are mounted. The hub 15 is mounted so as to be rotatable about an axis of rotation 16 and is connected to a generator 18. This exemplary embodiment concerns a direct-drive, that is to say gearbox-free, generator 18.

The rotor blade 13 has a rotor blade longitudinal axis 50 extending from a rotor blade root region 51 to a rotor blade tip region 52. The rotor blade tip region 52 encompasses a rotor blade tip and a directly adjoining region covering approximately 5% of the entire rotor blade 13. Analogously, the rotor blade root region 51 encompasses a rotor blade root and the adjoining 5% of the region of the entire rotor blade 13. Finally, the wind turbine 10 has a control device 17 for controlling a device for rotating the rotor 12 of the wind turbine 10.

FIG. 2 shows a detail of a rotor 12 and of a main shaft 46. The main shaft 46 is connected to a brake bracket 43. The brake bracket 43 is in the form of a disk. Brake pads 47 are attached to an outer edge of the brake bracket 43. The brake pads 47 can be pressed hydraulically against a brake disk 44. The brake disk 44 is a part of the rotor 12 and is mounted so as to be rotatable relative to the brake bracket 43 and relative to the main shaft 46. The brake disk 44, and the rotor 12 as a whole, can be blocked by means of a locking device 42.

FIGS. 3 and 4 show a first displacement unit 20 which is fastened to a brake bracket 43 and to a brake disk 44. Likewise shown are brake pads 47, which can be pressed against the brake disk 44. The first displacement unit 20 comprises a hydraulic displacement unit 22 and a further hydraulic displacement unit 23. The hydraulic displacement unit 22 is a hydraulic cylinder. The hydraulic cylinder is of circular construction. The hydraulic cylinder can be situated in a first stroke position as shown in FIG. 2. The first stroke position is also referred to as collapsed state or compressed state of the hydraulic cylinder. In this respect, in FIG. 4, the hydraulic cylinder is situated in an extended or deployed state, which is referred to as a second stroke position. In the first stroke position, the hydraulic cylinder has a length dimension of 2 m (meters). The further hydraulic displacement unit 23 comprises a further hydraulic cylinder which is of the same design as the hydraulic cylinder. The two hydraulic cylinders are parallel to one another. The two hydraulic cylinders are connected in a fixed and mechanically stable manner to the brake bracket 43 by means of a common element and by means of a common cutout. Said connection is however rotatable and/or has angular mobility. Furthermore, the hydraulic cylinders are fastened to a connecting element 25. The connecting element 25 comprises two connecting plates. The two connecting plates are arranged parallel to one another. One connecting plate is situated on one side of the brake disk 44, and the other connecting plate is situated on the other side of the brake disk 44. The brake disk 44 is part of the rotor 12 of the wind turbine 10. The connecting element 25 is releasably fastened to the brake disk 44 by means of a fastening device 24. The fastening device 24 comprises a first bolt and a second bolt.

As already mentioned, FIG. 4 shows the first displacement unit 20 in the second stroke position. In the second stroke position, the first displacement unit 20 is fastened to the brake disk 44 of the rotor 12 at a different location, offset upward, in relation to the first stroke position as shown in FIG. 3.

FIG. 5 shows a locking device 42. The locking device 42 is connected in a fixed and mechanically stable manner to a brake bracket 43. Furthermore, the locking device 42 is releasably connected to a brake disk 44 of a rotor 12. The locking device 42 shown in FIG. 5 has a first locking device bolt and a second locking device bolt.

FIG. 6 shows a first displacement unit 20 which is connected to a second displacement unit 21 by way of a connecting unit 28. Both the first displacement unit 20 and also the second displacement unit 21 are fastened to a tower bearing frame 27. The first displacement unit 20 shown in FIG. 5 has a lifting capacity of 250 t (tons). The second displacement unit has a lifting capacity of 30 t. A device comprising the first displacement unit and the second displacement unit can rotate a rotor of a wind turbine through up to 22.5° by means of a single stroke change movement.

The first displacement unit 20 and the second displacement unit 21 are situated in a line which is substantially parallel to an axis of rotation 16 of the rotor 12.

FIG. 7 shows support devices for supporting and for moving the two displacement units. The first displacement unit 20 is connected to a first radial support unit 30 and to a first axial support unit 31. The second displacement unit 21 is connected to a second radial support unit 32. A second axial support unit for the second displacement unit 21 is not required, because, with just the three support units shown, it is possible for the displacement units to be moved to an extent adequate for rotating the rotor.

Finally, FIG. 8 shows a safety device 45 for preventing an inadvertent release of a connection between the first displacement unit 20 and a rotor 12 (not shown). The first displacement unit 20 is connected to a second displacement unit 21 by means of a connecting unit 28. The two displacement units 20, 21 are connected in each case to a radial support unit 30, 32, specifically to a first radial support unit 30 and to a second radial support unit 32. The second radial support unit 32 and the second displacement unit 21 are connected to a tower bearing frame 27.

The first displacement unit 20 has a fastening device 24 which comprises a first bolt and a second bolt. The safety device 45 has a third bolt. All three bolts are suitable for being inserted into cutouts, designed for this purpose, of a rotor 12 or for example of a brake disk 44 (not shown).

1. A device for rotating a rotor of a wind turbine,
wherein
the wind turbine has the rotor, a tower, a nacelle with a machine frame, and a hub on which at least one rotor blade can be mounted,
the rotor is arranged so as to be rotatable relative to the nacelle about an axis of rotation,
the wind turbine has a locking device for blocking a rotational movement of the rotor about the axis of rotation,
the device has at least one first displacement unit which is fastened to the machine frame,
the first displacement unit has a fastening device by means of which the first displacement unit can be detachably fastened to the rotor, and
the fastening device is actuatable by at least one of electrically and hydraulically actuatable.

2. The device as claimed in claim 1,
wherein the fastening device is actuatable by means of a programmable control device.

3. The device as claimed in claim 1,
wherein the device comprises a connecting element which connects the fastening device to the first displacement unit.

4. The device as claimed in claim 1,
wherein
the machine frame has a brake bracket which is connected directly to a main shaft, and
the first displacement unit is fastened to the brake bracket.

5. The device as claimed in claim 1,
wherein
the rotor has a brake disk, and
the first displacement unit can be detachably fastened to the brake disk.

6. The device as claimed in claim 1,
wherein the first displacement unit comprises a hydraulic displacement unit, in particular a hydraulic cylinder.

7. The device as claimed in claim 1,
wherein the first displacement unit comprises a further hydraulic displacement unit, in particular a further hydraulic cylinder.

8. The device as claimed in claim 7,
wherein the hydraulic displacement unit and the further hydraulic displacement unit are arranged substantially parallel to one another.

9. The device as claimed in claim 1,
wherein the wind turbine is a direct-drive wind turbine.

10. The device as claimed in claim 1,
wherein
the device has at least one second displacement unit for assisting the rotation of the rotor, and
the second displacement unit is fastened to the machine frame.

11. The device as claimed in claim 10,
wherein
the first displacement unit and the second displacement unit are connected to one another by way of a connecting unit, and
the connecting unit is connected rotatably to the first displacement unit and rotatably to the second displacement unit.

12. The device as claimed in claim 10,
wherein the first displacement unit has a first support device and/or the second displacement unit has a second support device.

13. The device as claimed in claim 12,
wherein the first support device has
a first radial support unit which supports the first displacement unit in a substantially radial direction in a plane perpendicular to the axis of rotation, and/or
a first axial support unit which can displace the first displacement unit in a direction substantially parallel to the axis of rotation.

14. The device as claimed in claim 12,
wherein the second support device has
a second radial support unit which supports the second displacement unit in a substantially radial direction in a plane perpendicular to the axis of rotation, and/or
a second axial support unit which can displace the second displacement unit in a direction substantially parallel to the axis of rotation.

15. The device as claimed in claim 10,
wherein
the machine frame has a tower bearing frame, and
the second displacement unit is fastened to the tower bearing frame.

16. The device as claimed in claim 1,
wherein the first displacement unit has a safety device for preventing an inadvertent release of a connection between the first displacement unit and the rotor during the rotation of the rotor.

17. The device as claimed in claim 16,
wherein the safety device has a bolt, in particular a spring-actuated bolt, and the rotor has a cutout matched to the bolt.

18. A system for rotating a rotor of a wind turbine,
wherein the system has at least two devices for rotating the rotor of the wind turbine as claimed in claim 1.

19. The system as claimed in claim 18,
wherein the devices are situated around the circumference at substantially equal radial distances from the axis of rotation.

20. A method for rotating a rotor of a wind turbine by means of a device for rotating the rotor of the wind turbine wherein
the wind turbine has the rotor, a tower, a nacelle with a machine frame, and a hub on which at least one rotor blade can be mounted,
the rotor is arranged so as to be rotatable relative to the nacelle about an axis of rotation,
the wind turbine has a locking device for blocking a rotational movement of the rotor about the axis of rotation,
the device has at least one first displacement unit which is fastened to the machine frame,
the first displacement unit has a fastening device by means of which the first displacement unit can be detachably fastened to the rotor, and
the fastening device is actuatable by at least one of electrically and hydraulically actuatable.

21. The method as claimed in claim 20,
wherein the method comprises the following steps:
a) blocking the rotor by means of the locking device;
b) fastening the first displacement unit to the rotor by means of the fastening device;
c) releasing the locking device;
d) rotating the rotor from a first stroke position into a second stroke position by means of a first stroke change movement of the first displacement unit;
e) blocking the rotor by means of the locking device;
f) releasing the first displacement unit from the rotor; and
g) performing a second stroke change movement of the first displacement unit from the second stroke position into the first stroke position.

22. The method as claimed in claim 21,
wherein the rotor is rotated through at least 3 degrees by means of the first stroke change movement and/or by means of the second stroke change movement.

23. The method as claimed in claim 21,
wherein the rotor is rotated through at least 10 degrees by means of the first stroke change movement and/or by means of the second stroke change movement.

24. The method as claimed in claim 20,
wherein, in a further step, the rotor blade is mounted on the hub while a rotor blade longitudinal axis extending from a rotor blade tip region to a rotor blade root region is arranged substantially horizontally.

25. A method for rotating a rotor of a wind turbine by means of a system for rotating the rotor of the wind turbine as claimed in claim 18.
